(19) United States
(12) Patent Application Publication
(10) Pub. No.: US 2003/0193447 A1
(43) Pub. Date: Oct. 16, 2003

(54) Image displays

(76) Inventor: Errol James Stewart Greenlees, Somerset (GB)

Correspondence Address: BLANK ROME LLP, THE FARRAGUT BUILDING SUITE 1000, 900 17TH STREET NW, WASHINGTON, DC, 20006, US

(21) Appl. No.: 10/363,470

(22) PCT Filed: Sep. 4, 2001
(86) PCT No.: PCT/GB01/03963

(30) Foreign Application Priority Data
Sep. 4, 2000 (GB) 0021615.0

(51) Int. Cl. G09G 3/00

(52) U.S. Cl. 345/30

(57) ABSTRACT

An image display consisting of an image grid (11) having a plurality of successive strips (68A-D) of each image disposed in parallel relationship to each other, and a masking grid (9) having a plurality of parallel window strips (64A) through which some image strips (68A-D) are visible whilst others are obscured and different images can be observed by relative movement between the grids (9, 11), the grids (9, 11) including grid alignment means (60A, 66) for use in aligning the image strips (68AD) of the image grid (11) and the window strips (64A) of the masking grid (9) in substantially parallel relationship with each other, and further including grid registration means (60A, 61A-D, 62A-C) for bringing various of the images of the image grid (11) into registration with the window strips (64A) of the masking grid (9) when the grids (9, 11) are moved relative to each other after they have been brought into substantially parallel relationship with each other using the grid alignment means (60A, 66).

This invention concerns image displays and more particularly image displays consisting of an image grid having a plurality of successive strips of each image disposed in parallel relationship to each other, and a masking grid having a plurality of parallel window strips through which some image strips are visible whilst others are obscured and different images are observed by relative movement between the grids.

It is often desired to be able to display more than one image, for example poster images, at a particular site, and there have been a number of proposals hitherto for achieving this effect. Many of such proposals use an image grid which consists of juxtaposed strips of the respective images and an opaque masking grid having a plurality of transparent strips. Provided the transparent strips in the masking grid are spaced apart by the same distance as the repeat distance between adjacent strips of a particular poster on the image grid, individual posters can be seen through the transparent strips of the masking grid when the two grids are suitably aligned.

WO97/26642 describes such a system, the strips of the image and masking grids being maintained substantially parallel to each other by the drive mechanism itself, a cam and cam follower device being used to produce relative movement between the image and masking grids so that the strips on the masking grid are held in turn in line with the transparent strips for each of the separate images in the image grid. A screw threaded adjusting element is used to set the initial relative positions between the grids by hand when a new image grid is inserted into the system, this being used by an operator to set up the first display position. Thereafter alignment of strips on the image and masking grids relies on the mechanical accuracy of the drive mechanism, the accuracy of the printing of the image and masking grids, and the tolerances allowed for in the width of the transparent strips in the masking grid.

As an alternative to the cam and cam follower system used to bring about stepped relative movement between the image and masking grids, this document also proposes the use of one or more stepper motors to move a movable grid by rotating a threaded rod on which a mounting fixed to the grid is screw-threadedly and non-rotatably attached. A manual adjustment system is then provided to set up the initial position of the two grids in precise alignment or alternatively an automatic adjustment system is proposed in which the grids are very finely adjusted under the control of an electronic control unit by a suitable prime mover and a light sensing arrangement employed to detect alignment of two predetermined regions on the respective grids. It is further proposed that the electronic control unit could adjust the position of the grids according to the input signal from the light sensing arrangement to bring the grids into the required initial position, for example using the stepper motors used to step the grids to display successive images on the image grid.

WO 98/41967 describes similar display systems plus a further method of obtaining registration between individual image strips of the image and masking grids. In this document registration is achieved by reducing the width of outer portions of one transparent window located between two adjacent opaque strips of the masking grid and also reducing the effective widths of the corresponding edge portions of adjacent image strips of the image grid by making these edge portions opaque except for centrally disposed transparent portions. Registration of the window strips of the masking grid with the respective images of the image grid can then be effected using a photocell to detect light passing through the narrow windows in both grids, this being used to control upward and downward movement of the grids during normal operation of the system, for example to control linear drive mechanisms used to produce relative movement between the grids and the number of steps taken between successive images to compensate for backlash in the drive mechanism or for minor dimensional inaccuracies in the grids.

It is further proposed in this latter prior art document that positional information determined from these opposing edge portions of the image and masking grids be used to effect both vertical and horizontal registration of the image grid with the masking grid using arrangements of photocells, thereby ensuring that the image strips are parallel to the window strips.

Although the registration systems proposed in these prior art documents do enable registration to be achieved between the strips forming the individual images of the image grid and the window strips of the masking grid, there is a need for improved registration between the image and masking grids of display systems of the type described in these prior art documents.

According to the present invention there is provided an image display comprising an image grid having a plurality of successive strips of each image disposed in parallel relationship to each other, and a masking grid having a plurality of parallel window strips through which some image strips are visible whilst others are obscured and different images can be observed by relative movement between the grids, the grids including grid alignment means for use in aligning the image strips of the image grid and the window strips of the masking grid in substantially parallel relationship with each other, and further including grid registration means for bringing various of the images of the image grid into registration with the window strips of the masking grid when the grids are moved relative to each other after they have been brought into substantially parallel relationship with each other using the grid alignment means.

Image displays in accordance with the present invention can achieve a high degree of alignment between the image strips of the image grid and the window strips of the masking grid, thereby enabling the window strips of the masking grid to have a width which is a larger proportion of the width of the image strips than hitherto whilst avoiding the problem of more than one image strip being uncovered by a single window strip in the masking grid. The result is that larger amounts of light can be let through the displays enabling them to be brighter and/or more clearly visible in high ambient light levels such as in sunlight. Furthermore, the black lines of the masking grids become narrower and thereby provide images with particularly good resolution and improved visibility of detail on the image grids.

The grid alignment means preferably comprises indicia disposed in both edge portions of the respective grids, and more preferably the grid alignment means comprises indicia on the image and masking grids whereby light transmission through a first region of an edge portion of the grids changes with relative movement between the grids.

It is particularly preferred to achieve alignment when the light transmission through said first region is substantially half the difference between the maximum and minimum light transmission through said region when the image and masking grids are moved relative to each other, for example using a transparent window slot in one of the grids and a boundary line between an opaque region and a transparent region of the other grid which passes over the window slot with relative motion between the grids.

The grid registration means preferably comprises indicia disposed in both edge portions of the respective grids and more preferably indicia on the image and masking grids whereby light transmission through a second region of an edge portion of the grids changes with relative movement between the grids.

Registration is preferably achieved when light transmission through said second region is substantially half the difference between the maximum and minimum light transmission through said region when the image and masking grids are moved relative to each other.

The registration means preferably comprises a transparent window slot in one of the grids and a boundary line between an opaque region and a transparent region of the other grid.

More preferably the registration means enables registration between the grids to be effected in a plurality of relative positions between the image and masking grids so that individual images can be viewed with an optional dwell period therebetween.

The image grid or the masking grid preferably include a transparent window slot, with the other grid including a plurality of boundary lines between opaque and transparent regions whereby the plurality of relative positions can be achieved between the grids when the boundary lines pass over the transparent window slot.

The image strips of individual images of the image grid can be selected from opaque strips, strips including visual information, and substantially transparent strips.

The window strips of the masking grid are preferably narrower than the image strips of the image grid, thereby reducing the possibility that portions of more than one image will be displayed when the grids are intended to display a single image. However, there can be instances when it is preferred for the window strips of the masking grid to be of substantially the same width as the image strips of the image grid, for example to effect animation. A similar effect can be achieved by increasing the width of the window strips of the masking grid relative to the width of the image strips of the image grid, this again being useful in achieving an animation effect.

In some instances it is preferred that each image strip of image displays according to the present invention includes a plurality of image strips, this being of use in obtaining an effect of animation.

The registration means is preferably arranged to facilitate the display of a succession of image strips whereby an animated display is obtained, for example by adjacent positions for registration being at displacements between the image and masking grids which are greater than the respective widths of the image strips.

An embodiment of image display in accordance with the present invention will now be described with reference to the accompanying drawings in which:

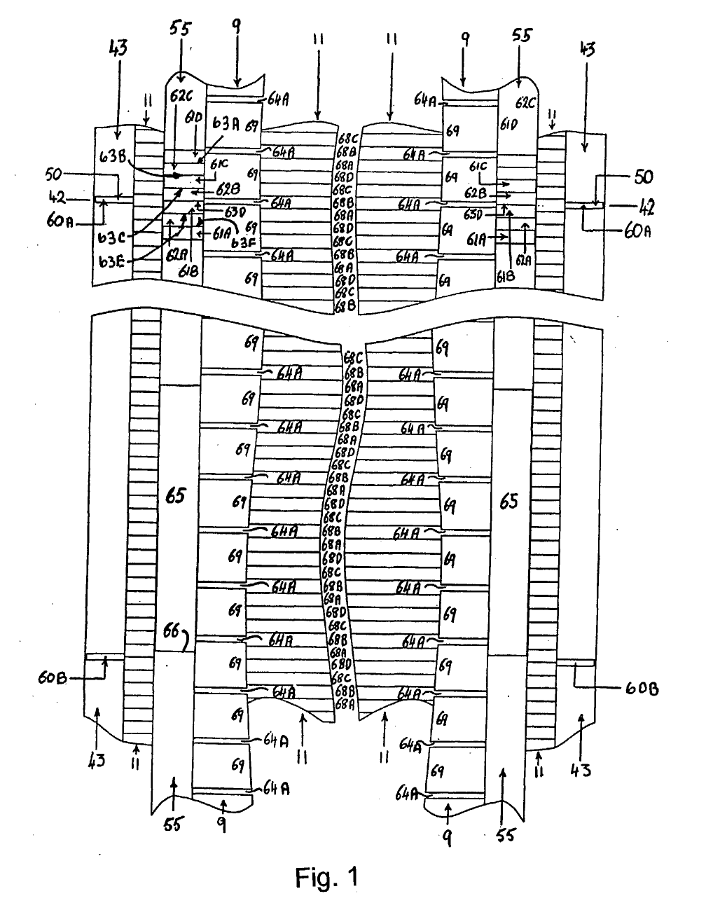

FIG. 1 shows detail of the pair of image and masking grids;

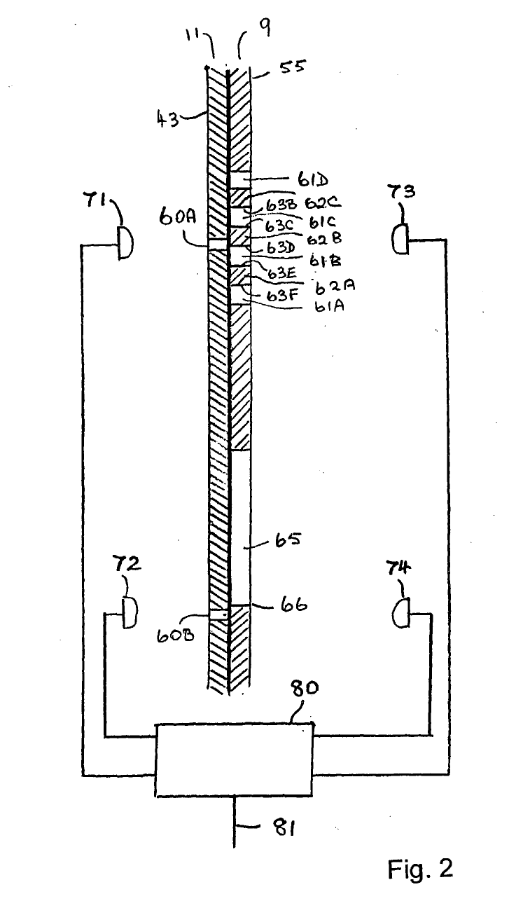

FIG. 2 shows the grids of FIG. 1 between light sources and detectors; and

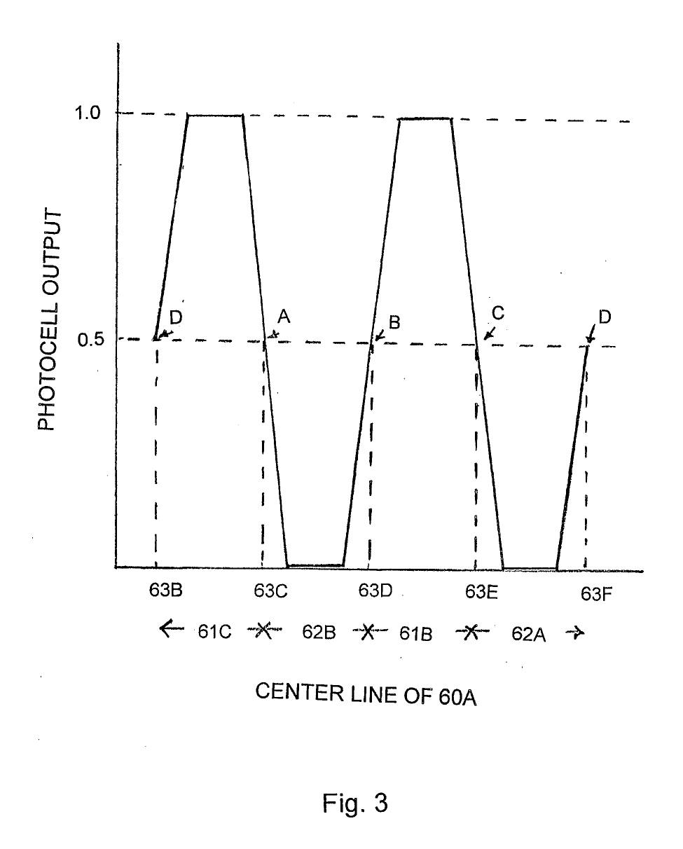

FIG. 3 shows the output from the detectors as the grids are moved relative to each other.

Referring to FIG. 1, opposite edge portions of a masking grid 9 and of an image grid 11 are shown overlaying each other, the portions of the grids 9 and 11 having been cut away and slid sideways from their positions in use so that details of the edge portions of the image grid 11 can be seen without being obscured by the masking grid 9.

The image grid 11 has a plurality of sets of parallel image strips 68A-D from four images A-D across its width, and-the masking grid has a plurality of horizontal transparent window strips 64A between masking strips 69 of the masking grid 9, the strips 64A being narrower than the image strips 68A-D, for example half their width, so that the image strips which are seen through the window strips 64A correspond to only one image at a time. Suitable positioning of the image grid 11 relative to the masking grid 9 enables each of the four images A-D on the image grid 11 to be seen through the window strips 64A in the masking grid 9, this being effected, for example, using a drive mechanism using stepper motors as described in WO98/41967.

The two outer edge portions 43 of image grid 11 are opaque apart from an upper horizontal transparent window slit 60A and a lower horizontal transparent window slit 60B, the upper slits 60A on opposing edges of the grid being in line with each other, as are the two lower slits 60B.

Slit 60A has its center line coincident with the center line of one of the image strips. Slit 60B has its center line coincident with the line between two adjacent image strips. The slits 60A and 60B are of equal width but are half the width of the image strips 68A-D.

In addition to the masking strips 69 on the masking grid 9, the two outer edge portions 55 of the grid 9 are opaque apart from both having four horizontal transparent window slits 61A-D separated by three opaque strips 62A-C, and a wider transparent window portion 65.

The window slits 61A-D and the opaque strips 62A-C therebetween are of equal width to each other and to the image strips 68A-D. The lower edge 63D of the opaque strip 62B is shown in FIG. 1 centered on one of the horizontal window strips 64A, for reasons which will subsequently be explained. The lower edge 66 of the window 65 in the opaque strips 55 on the masking grid 9 is centered on one of the image strips 68A-D, again for reasons which will subsequently be explained.

Referring to FIG. 1 in more detail, it will be seen that the masking grid 9 is positioned relative to the image grid 11 with the lower edge 63D of the opaque strip 62B on the center line of the window slit 60A in the opaque edge portion 43 of the image grid 11, the image 11 and masking grids 9 having been slid sideways relative to each other to show this. This position of the grids, apart from the sideways displacement, will subsequently be referred to as the mid-point of the displacement cycle. At the mid-point of the displacement cycle, the image revealed by the windows 64A in the masking grid 9 is image B formed from a plurality of image strips 68B.

The complete displacement cycle for the grids shown in the drawings consists of four incrementally upward and four incrementally downward movements of the masking grid 9 relative to the image grid 11, each of these movements being through a distance equal to the widths of the window slits 61A-D and the opaque strips 62A-C on the masking grid 9, and therefore to the width of the image strips 68A-D as they are all of the same width. Between each incremental movement in the displacement cycle, the speed of which can be varied according to the display system in which the grids are to be used, relative movement between the grids will usually be stopped so that each image can be viewed for a period of time, also referred to as the dwell time, before moving on to the next image. During the dwell time, the window strips 64A in the masking grid 9 are centered on the image strips 68A-D on the image grid 11 to display images A-D in turn, the masking grid 9 being moved up from the mid-point of the displacement cycle, then down to the bottom of the cycle before being returned to the top of the cycle after once again passing through mid-point of the displacement cycle.

As will be appreciated, accurate displacement of the masking grid 9 relative to the image grid 11 requires accurate control over the drive mechanism used to move the masking grid 9, and this can be achieved using the various slits and windows in the masking grid 9 and the image grid 11, as will now be described with reference to FIG. 2.

FIG. 2 is a side-on view of the masking grid 9 in contact with the image grid 11 and also in the relative positions shown in FIG. 1. Thus the line 63D between the opaque strip 62B and the window strip 61B is coincident with the center line of the upper window slit 60A.

Also shown in FIG. 2 are an upper light emitting diode (LED) 71 positioned opposite the upper window slot 60A, a lower LED 72 positioned opposite the lower window slit 60B, an upper photocell 73 opposite the upper window slit 60A, and a lower photocell 74 opposite the lower window slit 60B, the two grids 9 and 11 being positioned between the respective LEDs 71 and 72 and their associated photocells 73 and 74, respectively. A complementary set of two LEDs and photocells (not shown) is similarly positioned in relation to the other edge portions of the image grid 11 and the masking grid 9 so that both edge portions of the masks can be monitored simultaneously as will now be described.

Movement of the masking grid 9 relative to the image grid 11 will cause changes in the amount of light received by the photocells 73 from the LEDs 71, and these variations are used to control the drive mechanism used to move the masking grid 9 relative to the image grid 11. The result is that movement of the masking grid 9 can be used to control its own movement.

It is important to ensure that the individual image strips 68A-D are correctly positioned within the window strips 64A of the masking grid 9 during image cycling. More particularly, it is important to ensure that only one image strip appears within any one window strip 64A.

Correct initial positioning of the masking grid 9 relative to the image grid 11 is effected using the outputs from the photocell 74, and its partner (not shown) on the other edge of the grids, which respectively detect light from the LED 72 and its partner, the exact position being determined when the outputs from the respective photocells are half the maximum value obtained when the window 65 fully allows light to pass through the window slits 60B.

The output from the photocells which is taken as representing a half of the maximum amount of light detected by the respective photocells from the LEDs when the grids are moved relative to each other can be a computed half of this maximum, for example by using the maximum output during movement of the grids, or it can be a preset value. The former method has the advantage that it can automatically compensate for changes in the characteristics of the LEDs and the photocells, and for other changes during use such as dirt which may reduce the light transmission properties of the window strips. However, the latter has the advantage that it is relatively inexpensive to construct.

This initial positioning of the grids will usually have to be effected either when the display system is first switched on or when one or both of the grids is replaced. In either case, if on switching on the display system if either the photocell 74 or its partner (not shown), or both, detect light from the associated LEDs at a level which is not half of the maximum values which are observed when the window strips 60B are unobscured by the opaque strips 55, the control unit 80 sends a signal to the respective stepper motors of the display system to raise or lower the side or sides of the masking grid 9 until light levels detected by photocell 74 and its partner are both half the maximum value.

The boundaries 66 between the opaque strips 55 and the windows 65 are then on the center lines of the lower window strips 60B, and image cycling can then be started.

The position of the lower window slits 60B relative to the upper slits 60A is important because once the image strips 68A-D have been aligned with the window 64A, control of the drive mechanism for the masking grid 9 is passed to the output from the upper photocell 73 and its partner (not shown). Thus when the boundaries 66 are positioned half way across the lower window slits 60B, the opaque strip 62B completely obscures the slit 60A due to their relative positions on the respective grids.

By suitable programming of the control unit 80, both sides of the grid 9 are then moved upwardly by the same distance using their associated stepper motors from the position set using the lower window slits 60B and the boundaries 66 until the output from the photocell 73 and its partner are both half the maximum which detected when the upper window slit 60A is unobscured by the opaque portions 62A-C of the masking grid 9. The windows 64A in the masking grid 9 are then in line with the image strips 68B of the image grid 11, and so image B is displayed. A dwell period is then observed before the drive mechanism is re-started and the masking grid 9 is once again moved upwardly.

On re-starting the drive mechanism in the same direction as before, the window strip 61B will at first allow increasing amounts of light from the LED 71 to reach the photocell 73, following which decreasing amounts of light will reach the photocell 73 until a point is reached when the output from the photocell 73 is half maximum, thereby causing the control device 80 to send a signal along the control line 81 to stop the drive mechanism with the boundary edge 63E between the window strip 61B and the opaque strip 62A coincident with the center line of the window slot 60A. Image strips 68C will then be centered under window strips 64A in the masking grid with image C being displayed during a dwell period.

Further movement of the masking grid 9 in the same direction as before at first progressively obscures light from the LED 71 reaching the photocell 73 as the opaque strip 62A covers the window slot 60A, and it then allows light to pass through the window slot 60A as the window strip 61A passes over the window slot 60A. When the light passing through the window slot 60A becomes half the maximum, that is with the boundary 63F between the window strip 61A and the opaque strip 62A half way across the window slit 60A, the control unit 80 stops the stepper motors. Image strips 68D will then be centered under window strips 64A in the masking grid with image D being displayed during a dwell period.

Since this image cycling started from the mid-point of the displacement cycle, the direction of movement of the masking grid 9 is then reversed after a suitable dwell period. Thus the four step cycle for the illustrated image display can now be started from image D following which images C, B and A are displayed in turn, eventually reaching image D. The direction of movement of the masking grid 9 is changed again, and the images shown continue from image D at the change of direction back through images A, B and C back to D, from where the cycle can be repeated continuously.

As will be appreciated, without a correct positioning of the grids 9 and 11 relative to each other at the start of the above image cycling process, erroneous grid registration could result in the control unit 80 generating an incorrect sequence of images or misalignment of the image strips with the windows of the masking grid. Furthermore, erroneous grid registration could even result in mechanical damage to the display system displaying the images, for example as a result of the stepper motors working beyond their intended mechanical limits if the masking grid 9 was repeatedly to start its displacement cycle from a higher or lower position than normal.

The changes in output from the photocell 73 (and its partner) resulting from movement of the masking grid 9 relative to the image grid 11 are illustrated graphically in FIG. 3. The output from the photocell(s) is shown as a function of the position of the center line of the window slit 60A relative to the image grid 11.

Starting at the mid-point of the displacement cycle, 63D is positioned on the center line of the window slit 60A, and image B is displayed, the output from the photocell 73, and its companion, being 50% of maximum.

Upward movement of the masking grid 9 relative to the image grid 11 in the direction of line 63E results in the output at first increasing to a steady maximum, which is maintained during continued movement of the masking grid, and then decreasing from the maximum until line 63E coincides with the center line of window slit 60A and image C is displayed. A dwell period is then observed. Further upward movement of the masking grid results in a progressively decreasing output through an extended minimum, followed by an increase until line 63F coincides with the center line of window slit 60A. Image D is then displayed with a dwell period.

Reversing the direction of movement of the masking grid 9 relative to the image grid 11 results in the output from the photocell 73 and its partner decreasing and increasing as shown in FIG. 3 as the window slits 61B and 61C, and the opaque strips 62A and 62B, pass over the window slit 60A. The images shown at 50% of the maximum output from the photocells and the order in which they are displayed are also indicated in FIG. 3, dwell periods being observed to display the individual images when the output from the photocells 73 are half maximum.

As will be appreciated from FIG. 3, the maxima and minima of the output of the photocell 73 both last for appreciable proportions of the time during which relative movement is effected between the masking grid and the image grid, this being due to the window strips 60A being half the width, for example 0.2 mm, of both the window slits 61A-D and the opaque strips 62A-C, these then being 0.4 mm wide.

During image cycling as described above, the boundaries 66 pass across the window strips 60B, and this can be used to check, and if necessary adjust, the parallel relationship between the image strips 68A-D of the image grid 11 and the window strips 64A of the masking grid 9 by sending suitable signals from the control device 80 to the stepper motors to bring these strips back into parallel relationship. In general this will be used to return the grids to the mid-point of the displacement cycle because this also correctly aligns window strips 60A with the associated window strips 61A-D and opaque strips 62A-C. This is of particular advantage as it enables misalignments between the image and masking grids caused, for example, by physical vibration of the display system in which the grids are mounted.

As will be appreciated, instead of the image grid being stationary and moving the masking grid, the masking grid can be stationary and the image grid can be moved by the drive mechanism. It will also be appreciated that the window strips 60A and 60B can be on the masking grid rather than on the image grid. Furthermore, the window strips 60A and 60B need not necessarily be on the same grid.

The invention has been particularly described with reference to an image grid including strips from four images which are displayed in turn with equal dwell times However, it should be appreciated that the grids could be arranged to show different numbers of images than four, optionally with different dwell times.

The present invention also includes image grids having strips which are opaque and/or transparent, that is strips which contain no detailed visual information. Such grids can be used to create “blacked out” and transparent displays, respectively. For example, they can be used with or without image strips which provide detailed visual information, e.g. a picture of an object. They can be used, for example, to change from a dark display formed by opaque strips to an image formed by image strips, from an image formed by image strips to an object which can be seen through a clear display formed by transparent strips, or from a dark display formed by opaque strips via an image formed by image strips containing visual information to an object which can be seen behind a clear display formed by transparent strips. As will be appreciated, other permutations and combinations of image strips can be used to achieve a variety of effects using alignment and registration arrangements in accordance with the present invention.

Dwell times between successive images being displayed can be changed by simply changing the length of time the display system waits before activating the stepper motors to produce relative movement between the masking grid 9 and the image grid 11, these periods starting, for example, when the photocell 73 and its partner sense half maximum light intensity from LED 71 and its partner, respectively. However, the grids themselves can be used to control the relative displacement of the grids, for example by changing the respective widths of the window strips 61A-D and/or the opaque strips 62A-C. Such changes will usually be in multiples of the widths of the strips 61A-D and 62A-C as shown in FIG. 1.

It will also be appreciated that grids in accordance with the present invention can be used with a variety of display systems which produce different images on a display grid by movement of a masking grid which selectively obscures other images on an image grid whilst the desired image is displayed.

The present invention has the advantage that it enables grids for displaying a plurality of images to be particularly accurately aligned with an associated masking grid, thereby enabling wider window strips to be used in the masking grid with the result that brighter images can be achieved with the same illumination.

Relative movement between the image and masking grids during image cycling of the illustrated grids can result in the appearance of an animated image if the image strips are themselves composed of two or more image strips, for example four. Thus in a further aspect of the present invention there is provided a method of producing an animated image using an image display in accordance with the present invention, animation being effected by moving the grids relative to each other without a dwell period between one set of image strips and the next.

Using the grids described with reference to the accompanying drawings with the image strips 68D each being formed from strips of a single image and strips 68A-C each consisting of strips from four different images, moving the masking grid 9 from its lowest position below the mid-point of the displacement cycle, where image D is displayed, to its highest position above this mid-point, where image D is shown again, can produce an animated effect as a result of successively showing twelve images on strips 68A-C in rapid succession, the dwell periods and changes of direction only occurring at the furthest extents of the displacement cycle.

As will be appreciated, an animated effect can as a result be achieved in which one image is transformed into another through a succession of rapidly changing images which give rise to the appearance of animation.

1. An image display comprising an image grid having a plurality of successive strips of each image disposed in parallel relationship to each other, and a masking grid having a plurality of parallel window strips through which some image strips are visible whilst others are obscured and different images can be observed by relative movement between the grids, the grids including grid alignment means for use in aligning the image strips of the image grid and the window strips of the masking grid in substantially parallel relationship with each other, and further including grid registration means for bringing various of the images of the image grid into registration with the window strips of the masking grid when the grids are moved relative to each other after they have been brought into substantially parallel relationship with each other using the grid alignment means.

2. An image display according to claim 1, wherein the grid alignment means comprises indicia disposed in both edge portions of the respective grids.

3. An image display according to either of the preceding claims, wherein the grid alignment means comprises indicia on the image and masking grids whereby light transmission through a first region of an edge portion of the grids changes with relative movement between the grids.

4. An image display according to claim 3, wherein alignment is achieved when light transmission through said first region is substantially half the difference between the maximum and minimum light transmission through said region when the image and masking grids are moved relative to each other.

5. An image display according to any of the preceding claims, wherein the alignment means comprises a transparent window slot in one of the grids and a boundary line between an opaque region and a transparent region of the other grid.

6. An image display according to any of the preceding claims, wherein the grid registration means comprises indicia disposed in both edge portions of the respective grids.

7. An image display according to claim 5 or claim 6, wherein the grid registration means comprises indicia on the image and masking grids whereby light transmission through a second region of an edge portion of the grids changes with relative movement between the grids.

8. An image display according to claim 7, wherein registration is achieved when light transmission through said second region is substantially half the difference between the maximum and minimum light transmission through said region when the image and masking grids are moved relative to each other.

9. An image display according to any of the preceding claims, wherein the registration means comprises a transparent window slot in one of the grids and a boundary line between an opaque region and a transparent region of the other grid.

10. An image display according to any of the preceding claims, wherein the registration means enables registration between the grids to be effected in a plurality of relative positions between the image and masking grids whereby individual images can be viewed with a dwell period therebetween.

11. An image display according to claim 10, wherein the image grid or the masking grid includes a transparent window slot and the other grid includes a plurality of boundary lines between opaque and transparent regions whereby the plurality of relative positions can be achieved between the grids.

12. An image system according to any of the preceding claims, wherein the image strips of individual images are selected from opaque strips, strips including visual information, and transparent strips.

13. An image display according to any of the preceding claims, wherein the window strips of the masking grid are narrower than the image strips of the image grid.

14. An image display according to any of claims 1 to 12, wherein the window strips of the masking grid are of substantially the same width as the image strips of the image grid.

15. An image display according to and of the preceding claims, wherein each image strip includes a plurality of image strips.

16. An image display according to any of the preceding claims, wherein the registration means facilitates the display of a succession of image strips whereby an animated display is obtained.

17. An image display substantially as herein described with reference to the accompanying drawings.

18. A method of producing an animated image using an image display according to any of the preceding claims, which comprises moving the grids relative to each other without a dwell period between one set of image strips and the next.

19. A method of producing an animated image substantially as herein described with reference to the accompanying drawings.
